(19) United States
(12) Patent Application Publication
(10) Pub. No.: US 2023/0327144 A1
(43) Pub. Date: Oct. 12, 2023

(54) SEPARATOR PLATE AND METHOD FOR PRODUCING SAME

(71) Applicant: Reinz-Dichtungs-GmbH, Neu-Ulm (DE)

(72) Inventors: Andre SPEIDEL, Bussmannshausen (DE); Bernd GAUGLER, Ulm (DE); Stephan WENZEL, Pfaffenhofen (DE); Kurt HOEHE, Langenau (DE); Christoph SPECHT, Neu-Ulm (DE)

(21) Appl. No.: 18/296,953

(22) Filed: Apr. 6, 2023

(30) Foreign Application Priority Data
Apr. 7, 2022 (DE) 20 2022 101 861.8

(51) Int. Cl. H01M 8/0258; H01M 8/0247; H01M 8/0276

(52) U.S. Cl. CPC H01M 8/0258; H01M 8/0247; H01M 8/0276

(57) ABSTRACT

A separator plate comprising a first individual plate and a second individual plate, wherein the separator plate comprises: an electrochemically active region, at least one through-opening, and a bead arrangement. The bead arrangement arranged around the through-opening for sealing off the through-opening, A bead interior fluidically connected to the through-opening. At least one first aperture extending substantially parallel to a plate plane defined by the separator plate. At least one conveying channel which opens into a region of the first individual plate containing the first aperture and fluidically connects the bead interior to the first aperture.

### CROSS-REFERENCE TO RELATED APPLICATION

The present application claim priority to German Patent Application No. 20 2022 101 861.8, entitled “SEPARATOR PLATE AND METHOD FOR PRODUCING SAME”, filed Apr. 7, 2022. The entire contents of the above-listed application is hereby incorporated by reference for all purposes.

### TECHNICAL FIELD

The present disclosure relates to a separator plate for an electrochemical system, and to a method for producing same. The electrochemical system may be, for example, a fuel cell system, an electrochemical compressor, or an electrolyzer.

### BACKGROUND AND SUMMARY

Known electrochemical systems usually comprise a plurality of separator plates, which are arranged in a stack so that each two adjacent separator plates enclose an electrochemical cell. An electrochemical cell usually comprises a membrane, which is provided with electrodes and with a catalyst layer, and optionally gas diffusion layers facing towards the separator plates. For instance, the actual membrane is not formed over the entire surface of a separator plate, but instead extends substantially in the area that forms the electrochemically active region of the system. This is usually arranged substantially centrally and is surrounded by a frame. This frame is usually formed by an electrical insulator, for example a polymer-based film. The frame also has the task of electrically insulating adjacent separator plates from each other and thus avoiding a short-circuit. Besides the membrane, the electrodes and the catalyst layer(s), the membrane electrode assembly, hereinafter also abbreviated as MEA, also comprises the frame, which is sometimes also referred to as a reinforcing frame, but not the gas diffusion layer(s).

The separator plates usually each comprise two individual plates, which are connected to each other along their rear sides facing away from the electrochemical cells. The separator plates may serve, for example, for electrically contacting the electrodes of the individual electrochemical cells (for example fuel cells) and/or for electrically connecting adjacent cells (series connection of the cells). The separator plates may also be used to dissipate heat that is generated in the cells between the separator plates. Such waste heat may be generated, for example, during the conversion of electrical or chemical energy in a fuel cell. In the case of fuel cells, bipolar plates are often used as separator plates.

The separator plates or the individual plates of the separator plates usually each have at least one through-opening. In the separator plate stack of the electrochemical system, the through-openings of the stacked separator plates, which through-openings are arranged in an aligned or at least partially overlapping manner, then form media channels for supplying or discharging media. The through-openings are accordingly also formed in the frame of the membrane electrode assembly. For example, the through-openings in the frame are formed with a smaller diameter than in the separator plates so that the resulting overhang of the frame insulates the adjacent separator plates from each other. In order to seal off the through-openings or the media channels formed by the through-openings of the separator plates, known separator plates also have bead arrangements, which are arranged in each case around the through-opening of the separator plate.

The individual plates of the separator plate may additionally have channel structures for supplying one or more media to an active region of the separator plate and/or for conveying media away therefrom. The active region of the separator plate is usually defined in such a way that it may for example enclose or bound the active region of an electrochemical cell. By way of example, the media may be fuels (for example hydrogen or methanol), reaction gases (for example air or oxygen) or a coolant as supplied media, and reaction products and heated coolant as discharged media. In the case of fuel cells, the reaction media, e.g. fuel and reaction gases, are usually guided on the surfaces of the individual plates that face away from each other, while the coolant is guided between the individual plates.

The flanks of the bead arrangement arranged around the through-opening of the separator plate may have one or more apertures, as shown for example in DE 102 48 531 A1. These apertures serve to establish a fluid connection between the through-opening of the separator plate and the active region of the separator plate. After the individual plate has been embossed, the apertures are usually created by punching or cutting the plate material. However, since the apertures are located in the flanks of the bead arrangement, a relatively complicated 3D cut is required. In addition, the apertures may form sharp edges, which may damage the MEA, for example the film of the reinforcing frame, or may even perforate it or cause relatively large cracks therein. The apertures formed in the bead flank also cause a local weakening of the bead flank, as a result of which the stiffness of the latter is reduced in some regions.

It is also known from document DE 102 48 531 A1 that the separator plate may have one or more conveying channels instead of the apertures formed in the bead flank, which conveying channels adjoin the bead flank on an outer side of the bead arrangement and are in fluid connection with a bead interior of the bead arrangement. Such conveying channels which adjoin the bead flank may be combined with, for example, bead-like channel sections, as shown in WO 2020/174038 A1. The supply of a medium from the through-opening, through the bead arrangement, to the electrochemically active region of the separator plate can take place in an even more targeted manner with the aid of such conveying channels. Such conveying channels may also improve the discharging of the medium from the electrochemically active region, through the bead arrangement, to the through-opening. Overall, therefore, the efficiency of the electrochemical system can be increased.

The aforementioned conveying and distribution channels are therefore part of a fluid connection of the through-opening to the electrochemically active region and as such are provided only in a section of the bead arrangement that usually extends between the through-opening and the electrochemically active region. However, this asymmetrical design of the bead arrangement may lead to inhomogeneous bead compression in the stack, which in turn may lead to leaks in the stack or system.

The object of the present disclosure is to provide a separator plate for an electrochemical system that at least partially solves the problems mentioned above. The object of the present disclosure is also to provide a method for producing such a separator plate.

This object is achieved by a separator plate for an electrochemical system according to the independent claims, and by a method for producing such a separator plate according to the further independent claim. Specific embodiments are described in the dependent claims and in the description below.

Accordingly, a separator plate for an electrochemical system is proposed, comprising a first individual plate and a second individual plate, which are connected to each other. In a first variant, the separator plate comprises the following:
an electrochemically active region,
at least one through-opening for the passage of a fluid,
a bead arrangement arranged around the through-opening for sealing off the through-opening, wherein a bead interior is fluidically connected to the through-opening,
at least one first aperture formed in the first individual plate, which aperture extends substantially parallel to a plate plane defined by the separator plate, and
at least one conveying channel formed in the second individual plate, which conveying channel is arranged on one side of the bead arrangement.

The conveying channel formed in the second individual plate leads opens a region of the first individual plate containing the first aperture. “Region of the first individual plate containing the first aperture” may refer either to opening directly into the first aperture or to opening indirectly into the first aperture, with the flow still passing through a fluid space spanned by the first individual plate. In addition, the conveying channel formed in the second individual plate fluidically connects the bead interior of the bead arrangement to the first aperture formed in the first individual plate.

Since the first aperture extends substantially parallel to the plate plane, the first aperture can be punched or cut parallel to the plate plane. There is thus no need for complicated 3D cuts when creating the first aperture. This also reduces the risk of damage being caused to the MEA, for example its reinforcing frame, by angled, sharp edges of the first aperture.

The first aperture is therefore not formed in a bead flank of the bead arrangement that extends at an angle to the plate plane. The first aperture is usually also spaced apart from the bead arrangement. The first aperture may be located, for example, on a side of the bead arrangement facing towards the through-opening or on a side of the bead arrangement facing towards the active region. The conveying channel may accordingly be arranged on a side of the bead arrangement facing away from the through-opening or on a side of the bead arrangement facing towards the through-opening.

The conveying channel may be formed by the plate material of the second individual plate. The present disclosure therefore also encompasses a method for producing a separator plate. In said method, the bead arrangement and/or the at least one conveying channel is integrally formed in the individual plate(s), such as the conveying channel of the second individual plate is integrally formed in the second individual plate, by hydroforming, deep-drawing and/or embossing, such as vertical and/or roller embossing. In the description below, the term “embossing” or “embossed” can be understood to refer to hydroforming, roller embossing, vertical embossing and/or deep-drawing. This method step is usually carried out simultaneously with the integral formation of the other flow-guiding structures, such as the fluid-guiding channels of the electrochemically active region. For example, in the case of large separator plates, roller embossing may require lower pressing forces per formed unit area than the other methods mentioned.

Furthermore, the at least one first aperture may be created in the first individual plate, in particular may be punched out of the latter, before or after the bead arrangement has been integrally formed. A vertical and/or rolling punching process can be used for this. It is possible for these simple methods to be used, for example after the aforementioned structures have been integrally formed, since the first aperture extends substantially parallel to the plate plane. Cutting or punching in surfaces which are sloping—e.g. at an angle to the plate plane—is more difficult to implement with regard to the process and the tools and may cause sharp edges.

In the context of this specification, a fluid connection or a fluidic connection may be a direct connection without intermediate elements or an indirect connection by way of additional intermediate elements.

The fluidic connection of the bead interior to the first aperture formed in the first individual plate by means of the conveying channel formed in the second individual plate may be established without intermediate channels or conveying sections—e.g. by means of a direct fluidic connection—or alternatively via further channels or conveying sections—e.g. via an indirect fluidic connection. These further channels or conveying sections for establishing the fluidic connection between the conveying channel formed in the second individual plate and the bead interior may be present, for example, in the first individual plate and/or in the second individual plate.

The expressions “substantially parallel” and “substantially orthogonal” with regard to two components are intended to include manufacturing tolerances and in the context of the present specification are intended to mean that slight deviations from parallelism or orthogonality are permitted, so that a corresponding angle between the respective components may deviate by between at most −30° and/or +30°, −20° and/or +20°, −10° and/or +10°, or even −5° and/or +5°. This is also intended to apply to the size of the aperture.

It may be provided that an orthogonal projection of the first aperture perpendicular to the plate plane onto the second individual plate defines a projection area, wherein the second individual plate has at least part of the conveying channel in the region of the projection area.

Often, at least in some regions, the conveying channel extends from the bead arrangement in the direction of the electrochemically active region. It may be provided that, at least in some regions, the conveying channel extends substantially parallel, at an angle and/or perpendicular to a main direction of extension of the bead arrangement. The conveying channel may therefore comprise various sections, which are fluidically connected to each other and extend in different directions. The conveying channel may adjoin the bead arrangement, such as a bead flank of the bead arrangement.

The main direction of extension of the bead arrangement is usually substantially parallel to an edge that bounds the through-opening. If the bead arrangement comprises a wavy course with convex and concave sections, the convex and concave sections of the wavy course in each case merge into each other at a turning point. The aforementioned main direction of extension is then superimposed on the wavy shape of the bead arrangement. The main direction of extension then results from the line connecting the turning points of the neutral axis of the bead arrangement, such as of the bead top of the bead arrangement.

Optionally, at least one conveying channel is provided in the first individual plate, which conveying channel may be designed as a fluidic connection piece between the bead interior and the conveying channel in the second individual plate. For example, the first individual plate may have a conveying channel which is fluidically connected to the bead interior, in some regions overlaps with the conveying channel of the second individual plate and is spaced apart from the first aperture.

However, it is also possible that no conveying channel is formed in the first individual plate, or else just one conveying channel which is only fluidically connected to the bead interior via the conveying channel in the second individual plate. It may therefore be provided that, in the first individual plate, no conveying channel extends between the bead arrangement and the first aperture.

The expression “between two elements” may on the one hand refer only to the points on the shortest straight connecting line between the two elements. As an alternative or in addition, it may also refer to points located on further, non-shortest straight lines connecting the elements, which enclose at most an angle of 45° with the shortest straight connecting line.

The at least one conveying channel may have a bead-like structure with a top and a respective flank on each side thereof, which flanks, at a bead foot, pass tangentially into a plane extending parallel to the plate plane. The top may be curved or flat in cross-section. In the direction of extension of the conveying channel, the top may be planar or arranged at an angle.

If conveying channels are formed both in the second individual plate and in the first individual plate, said conveying channels may extend in a fully or partially overlapping manner in orthogonal projection onto the plate plane or may also be completely offset from each other. For example, sections of the conveying channels that directly adjoin the flank of the bead arrangement, e.g. sections extend substantially perpendicular to the bead arrangement, may extend in a fully or partially overlapping manner or may be completely offset from each other.

In one embodiment, the first aperture is formed in a region of the plate that lies in a plate plane of the first individual plate. Alternatively, the first aperture may be formed in an embossed region of the plate. For example, the first aperture may be surrounded by an embossed structure, which protrudes out of the plate plane for example in the same direction as the bead arrangement. A height of the embossed region or of the embossed structure, measured perpendicular to the plate plane, may be smaller than a height of the bead arrangement, for example in the non-compressed state of the plate stack and/or the bead arrangement. The embossed region may form a plateau, in which the first aperture is formed; however, the embossed region may also form a bead which is closed on itself in the manner of a ring, wherein the first aperture is formed in the region surrounded by the bead and thus lies in a different plane than the projecting regions of the bead. By way of example, the bead may extend in a plane that extends between the plane of the bead top and the plate plane of the first individual plate, while the aperture extends in the plate plane of the first individual plate or in a plane between the plate plane of the first individual plate and the plane of the projecting region of the bead. The embossed region or the embossed structure containing the aperture may have, for example, an oval, rounded-rectangular or elliptical basic shape or may extend in the manner of a channel, for example at least partially along the conveying channel formed in the second individual plate.

It is also possible that a plurality of first apertures are formed in the first individual plate. In this case, it may be that these apertures are arranged on the side of the bead arrangement facing away from the through-opening and/or on the side of the bead arrangement facing towards the through-opening such that, in the first individual plate, an embossed structure is formed, at least in some sections, between at least two of the two first apertures. The embossed structure may be designed such that it extends away from the plate plane in the same direction as the bead arrangement. The embossed structure may have an oval, rounded-rectangular or elliptical basic shape and may be arranged centrally between the two first apertures. As an alternative or in addition, at least one conveying channel may also extend as an embossed structure, at least in some sections, between the two first apertures.

A contact area for the MEA reinforcing frame may be provided both by means of a bead-like embossed structure, which surrounds at least one aperture, and by a separate embossed structure, the contact area being spaced apart from the plane of the aperture so that a sufficient flow space is spanned for the medium flowing through the at least one first aperture or the at least two first apertures. There is no need for either the embossed structure or the bead-like embossed structure to extend in a plane parallel to the plate plane; they may also extend at an angle to the plate plane.

The first aperture may alternatively be surrounded, such as partially surrounded, for example, by an embossed structure which projects out of the plate plane in the opposite direction to the bead arrangement. Such a first aperture may therefore extend in a plane that also extends within the conveying channel of the second individual plate.

Optionally, the first individual plate may have a first sealing bead arranged around the through-opening for sealing off the through-opening. The second individual plate may accordingly have a second sealing bead arranged around the through-opening for sealing off the through-opening. The first sealing bead and the second sealing bead may be arranged in an overlapping manner and may form the aforementioned bead arrangement with a common sealing bead interior, which is fluidically connected to the through-opening of the separator plate. The first sealing bead and the second sealing bead are typically formed on opposite sides of the separator plate and usually point away from each other with their bead tops. The first sealing bead and the second sealing bead are usually designed as full beads and accordingly each usually comprise two bead flanks. The bead flanks of the respective sealing beads are often connected to each other by a straight or curved bead top. Alternatively, it is possible that the sealing bead interior is spanned by just one sealing bead in one of the first and second individual plates, e.g. only in the first or only in the second individual plate, and the complementary individual plate extends for example in a flat manner in the regions in question.

It may be provided that, at least in some regions, the conveying channel extends from the second sealing bead in the direction of the electrochemically active region or in the direction of the through-opening. The conveying channel may adjoin the second sealing bead, such as a bead flank of the second sealing bead.

The present disclosure permits a large number of combinations with regard to the number of conveying channels and first apertures. In a first variant, one first aperture in the first individual plate is connected to one conveying channel in the second individual plate, for instance a conveying channel extending substantially perpendicular to the bead arrangement. However, it is also possible that a plurality of first apertures in the first individual plate overlap with one conveying channel in the second individual plate, at least in some sections, so that one conveying channel is in fluid connection with a plurality of apertures. It is also possible to feed at least two first apertures from a single conveying channel in the second individual plate, which conveying channel extends perpendicular to the bead arrangement, or to discharge fluid from these first apertures via this conveying channel. It is also possible to overlap, in some sections, one first aperture in the first individual plate with a plurality of conveying channels in the second individual plate and thereby fluidically connect it thereto.

In a second variant of the present disclosure, the separator plate comprises the following:
an electrochemically active region,
at least one through-opening for the passage of a fluid,
a bead arrangement arranged around the through-opening, at least in one of the individual plates, for sealing off the through-opening, wherein a bead interior is fluidically connected to the through-opening,
at least one first aperture formed in the first individual plate, which aperture extends substantially parallel to a plate plane defined by the separator plate, and
at least one conveying channel formed in one of the individual plates, which conveying channel is arranged on one side of the bead arrangement.

In this variant, too, the conveying channel opens into a region of the first individual plate containing the first aperture, such as a region spanned by the first individual plate and containing the first aperture, and fluidically connects the bead interior of the bead arrangement to the first aperture formed in the first individual plate. Once again, it is not necessary for the aperture to be formed by means of a complicated 3D punching process; instead, it can be created by means of a simple 2D punching process.

In this second variant, the conveying channel may be integrally formed in the first individual plate. The conveying channel may be formed by the plate material of the first individual plate. In this second variant, a bead arrangement may extend around the through-opening in the second layer, but it is also possible that no corresponding bead arrangement is formed in the second layer.

Many of the above-mentioned embodiments of the first variant, including the method, can also be realized with the second variant of the present disclosure, provided that they do not conflict therewith.

In both variants, the first individual plate may have at least one first through-opening for the passage of a fluid, wherein the second individual plate has a second through-opening for the passage of the fluid. The first through-opening and the second through-opening are usually arranged in alignment or in an overlapping manner at least in some sections and form the aforementioned through-opening of the separator plate, around which the bead arrangement is arranged.

As indicated above, the through-opening may be designed for the passage of a reaction medium, such as a reaction gas, or a coolant, such as a cooling fluid. A through-opening may form an inlet opening or feed opening or an outlet opening or discharge opening for the fluid. In the present specification, a conveying sequence leading from the edge of a through-opening to a first aperture is also referred to as a bead passage since it serves to enable a fluid to pass through the region crossed by the bead arrangement.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

Exemplary embodiments of the separator plate and of the electrochemical system are shown in the figures and will be explained in greater detail on the basis of the following description.

### BRIEF DESCRIPTION OF THE FIGURES

FIG. 1 schematically shows, in a perspective view, an electrochemical system comprising a plurality of separator plates or bipolar plates arranged in a stack.

FIG. 2 schematically shows, in a perspective view, two bipolar plates of the system according to FIG. 1 with a membrane electrode assembly (MEA) arranged between the bipolar plates.

FIGS. 3A-C show a further example of a separator plate with conveying channels adjoining the bead arrangement in two directions, according to the prior art, in a plan view, a schematic detail view and a sectional view.

FIG. 4A shows a perspective view of a passage through a bead arrangement of a separator plate with conveying channels adjoining the bead arrangement in one direction, according to the prior art.

FIG. 4B shows a sectional view of the bead passage of FIG. 4A.

FIG. 5A shows a perspective view of a group of bead passages of a separator plate according to the first variant of the present disclosure.

FIG. 5B shows the arrangement of FIG. 5A in a plan view.

FIGS. 5C-F show various sectional views through the separator plate of FIG. 5B.

FIG. 5G shows the separator plate of FIGS. 5A and 5B in a view from below.

FIG. 6A shows a group of bead passages of a further separator plate in a plan view.

FIGS. 6B-C show various sectional views through the separator plate of FIG. 6A.

FIG. 6D shows the separator plate of FIG. 6A in a view from below.

FIG. 7A shows a group of bead passages of a further separator plate in a plan view.

FIGS. 7B-C show various sectional views of the separator plate of FIG. 7A.

FIG. 7D shows the separator plate of FIG. 7A in a view from below.

FIG. 8A shows a group of bead passages of a further separator plate in a plan view.

FIGS. 8B-C show various sectional views of the separator plate of FIG. 8A.

FIG. 8D shows the separator plate of FIG. 8A in a view from below.

FIG. 9A shows a group of bead passages of a further separator plate in a plan view.

FIGS. 9B-C show various sectional views of the separator plate of FIG. 9A.

FIG. 9D shows the separator plate of FIG. 9A in a view from below.

FIG. 10A shows a group of bead passages of a further separator plate in a plan view.

FIGS. 10B-C show various sectional views of the separator plate of FIG. 10A.

FIG. 10D shows the separator plate of FIG. 10A in a view from below.

FIG. 11A shows a group of bead passages of a further separator plate in a plan view.

FIGS. 11B-C show various sectional views of the separator plate of FIG. 11A.

FIG. 11D shows the separator plate of FIG. 11A in a view from below.

FIG. 12A shows a group of bead passages of a further separator plate in a plan view.

FIGS. 12B-C show various sectional views of the separator plate of FIG. 12A.

FIG. 12D shows the separator plate of FIG. 12A in a view from below.

FIG. 12E shows a perspective view of the separator plate of FIG. 12A.

FIG. 13A shows a group of bead passages of a separator plate in a plan view.

FIGS. 13B-C show various sectional views of the separator plate of FIG. 13A.

FIG. 13D shows the separator plate of FIG. 13A in a view from below.

FIG. 14A shows a group of bead passages of a separator plate according to the second variant of the present disclosure in a plan view.

FIGS. 14B-C show various sectional views of the separator plate of FIG. 14A.

FIG. 14D shows the separator plate of FIG. 14A in a view from below.

FIG. 15A shows a group of bead passages of a further separator plate according to the first variant of the present disclosure in a plan view.

FIGS. 15B-C show various sectional views of the separator plate of FIG. 15A.

FIG. 15D shows the separator plate of FIG. 15A in a view from below.

FIG. 16A shows a group of bead passages of a further separator plate according to the first variant of the present disclosure in a plan view.

FIGS. 16B-E show various sectional views of the separator plate of FIG. 16A.

FIG. 16F shows the separator plate of FIG. 16A in a view from below.

FIG. 17A shows a group of bead passages of a further separator plate in a plan view.

FIGS. 17B-E show various sectional views of the separator plate of FIG. 17A.

FIG. 17F shows the separator plate of FIG. 17A in a view from below.

FIG. 18A shows a group of bead passages of a further separator plate in a plan view.

FIGS. 18B-C show various sectional views of the separator plate of FIG. 18A.

FIG. 18D shows the separator plate of FIG. 18A in a view from below.

FIG. 19 shows flow diagrams of methods for producing the separator plate.

Here and below, features that recur in different figures are denoted by the same or similar reference signs.

### DETAILED DESCRIPTION

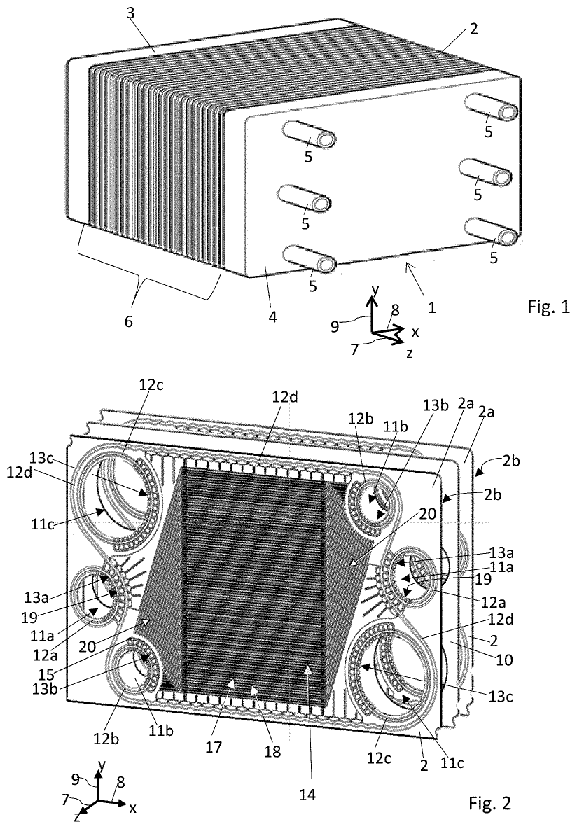

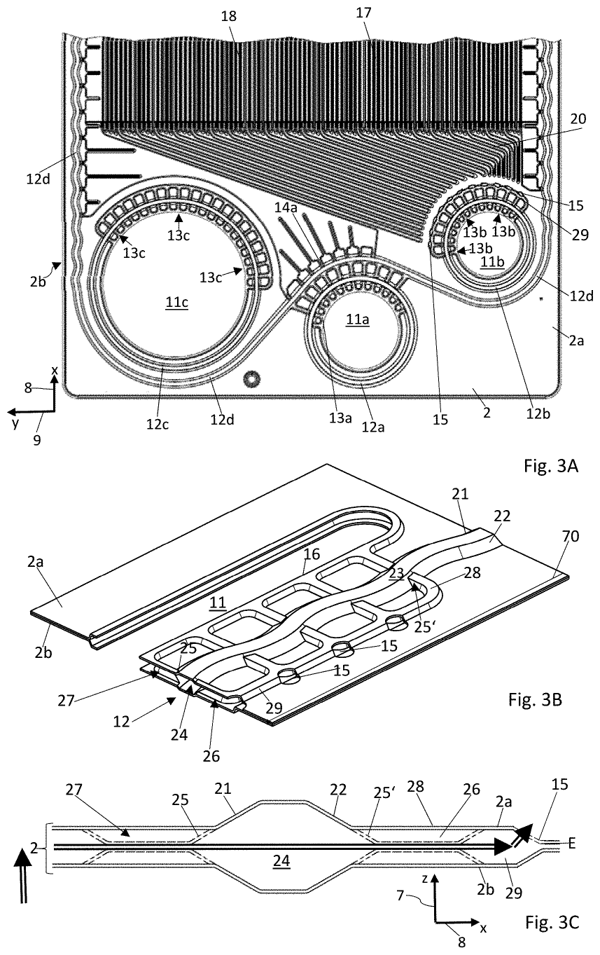

FIG. 1 shows an electrochemical system 1 comprising a plurality of structurally identical metal separator plates 2, which are arranged in a stack 6 and are stacked along a z-direction 7. The separator plates 2 of the stack 6 are usually clamped between two end plates 3, 4. The z-direction 7 is also referred to as the stacking direction. In the present example, the system 1 is a fuel cell stack. Each two adjacent separator plates 2 of the stack thus bound an electrochemical cell, which serves for example to convert chemical energy into electrical energy. To form the electrochemical cells of the system 1, a membrane electrode assembly (MEA) 10 is arranged in each case between adjacent separator plates 2 of the stack (see, for example, FIG. 2). Each MEA 10 typically contains at least one membrane, for example an electrolyte membrane. Furthermore, a gas diffusion layer (GDL) may be arranged on one or both surfaces of the MEA. The MEA 10 often additionally comprises a frame-like reinforcing layer, which frames the electrolyte membrane and reinforces it. The reinforcing layer is usually electrically insulating and prevents a short-circuit from occurring during operation of the electrochemical system 1.

In alternative embodiments, the system 1 may also be designed as an electrolyzer, as an electrochemical compressor, or as a redox flow battery. Separator plates can likewise be used in these electrochemical systems. The structure of these separator plates may then correspond to the structure of the separator plates 2 explained in detail here, although the media guided on and/or through the separator plates in the case of an electrolyzer, an electrochemical compressor or a redox flow battery may differ in each case from the media used for a fuel cell system.

The z-axis 7, together with an x-axis 8 and a y-axis 9, spans a right-handed Cartesian coordinate system. The separator plates 2 each define a plate plane, each of the plate planes of the separator plates being oriented parallel to the x-y plane and thus perpendicular to the stacking direction or to the z-axis 7. The end plate 4 usually has a plurality of media ports 5, via which media can be supplied to the system 1 and via which media can be discharged from the system 1. Said media that can be supplied to the system 1 and discharged from the system 1 may comprise for example fuels such as molecular hydrogen or methanol, reaction gases such as air or oxygen, reaction products such as water vapor or depleted fuels, or coolants such as water and/or glycol.

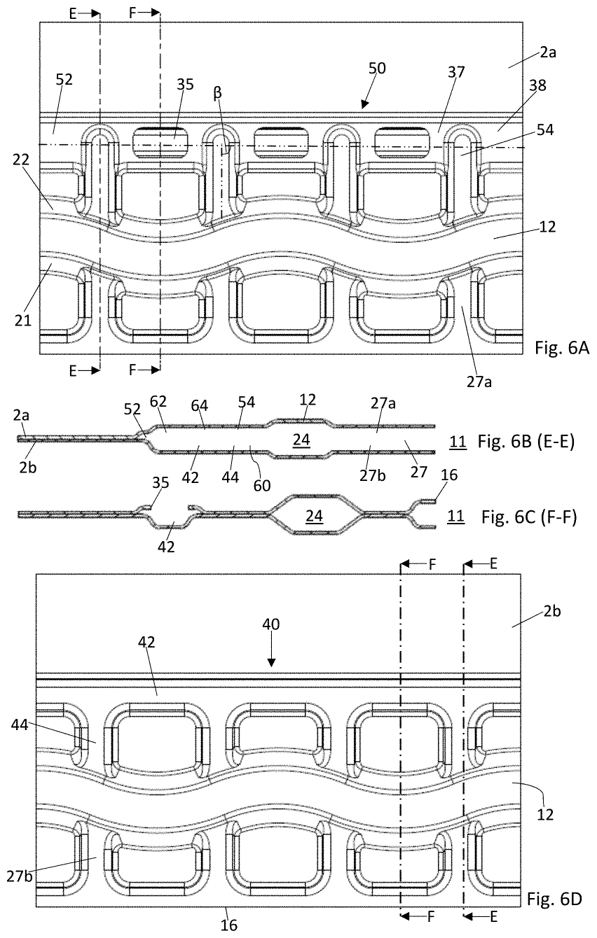

Both known separator plates, as shown in FIGS. 2 to 4, and separator plates according to the present disclosure, as shown from FIG. 5 onwards, can be used in an electrochemical system as shown in FIG. 1.

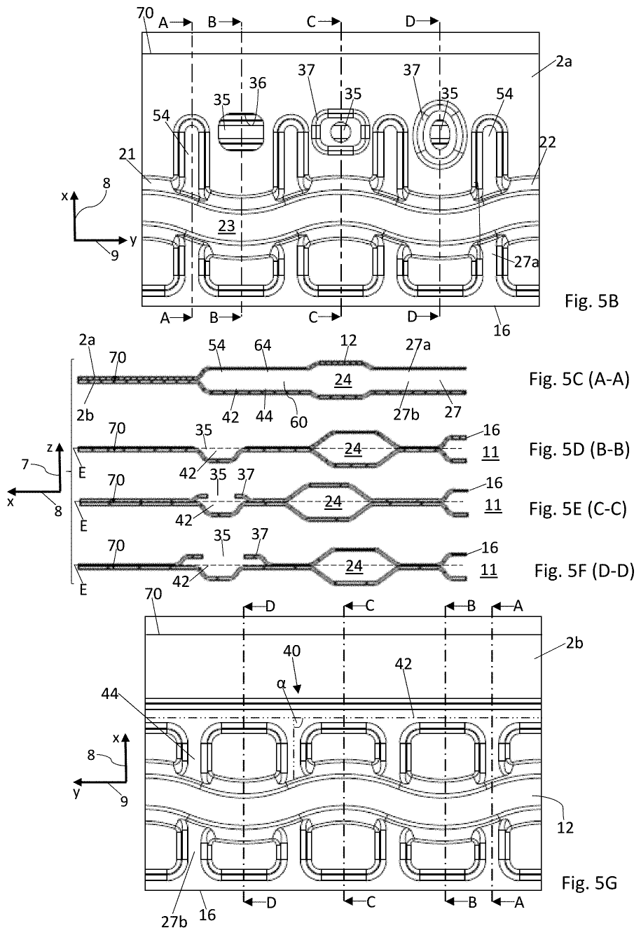

FIG. 2 shows, in a perspective view, two adjacent separator plates 2, known from the prior art, of an electrochemical system of the same type as the system 1 from FIG. 1, as well as a membrane electrode assembly (MEA) 10 which is arranged between these adjacent separator plates 2 and is likewise known from the prior art, the MEA 10 in FIG. 2 being largely obscured by the separator plate 2 facing towards the viewer. The separator plate 2 is formed of two individual plates 2a, 2b which are joined together in a materially bonded manner (see also, for example, FIGS. 4A, 4B), of which only the first individual plate 2a facing towards the viewer is visible in FIG. 2, said first individual plate obscuring the second individual plate 2b. The individual plates 2a, 2b may each be manufactured from a metal sheet, for example from a stainless-steel sheet. The individual plates 2a, 2b may for example be welded to each other along their outer edge, for example by laser-welded joints.

The individual plates 2a, 2b typically have through-openings, which are aligned with one another and form through-openings 11a-c of the separator plate 2. When a plurality of separator plates of the same type as the separator plate 2 are stacked, the through-openings 11a-c form fluid-guiding lines which extend through the stack 6 in the stacking direction 7 (see FIG. 1). Typically, each of the lines formed by the through-openings 11a-c is fluidically connected to one of the ports 5 in the end plate 4 of the system 1. For example, coolant can be introduced into the stack 6 via the lines formed by the through-openings 11a, while the coolant can be discharged from the stack via other through-openings 11a. In contrast, the fluid-guiding lines formed by the through-openings 11b, 11c may be designed to supply fuel and reaction gas to the electrochemical cells of the fuel cell stack 6 of the system 1 and to discharge the reaction products from the stack. The media-guiding through-openings 11a-c are substantially parallel to the plate plane.

In order to seal off the through-openings 11a-c with respect to the interior of the stack 6 and with respect to the surrounding environment, the first individual plates 2a may each have sealing arrangements in the form of sealing beads 12a-c, which are arranged in each case around the through-openings 11a-c and in each case completely surround the through-openings 11a-c. On the rear side of the separator plates 2, facing away from the viewer of FIG. 2, the second individual plates 2b have corresponding sealing beads for sealing off the through-openings 11a-c (not shown). A bead arrangement 12 of the separator plate 2 can be understood as a combination of two sealing beads 12a of the individual plates 2a, 2b, sealing beads 12b of the individual plates 2a, 2b or sealing beads 12c of the individual plates 2a, 2b, which sealing beads cooperate, point away from each other and are located on opposite sides of the separator plate 2. However, as shown below, a bead arrangement 12 of the separator plate 2 may also only consist in one bead, meaning that only one of the individual plates 2a, 2b comprises a sealing bead 12a, 12b, 12c.

In an electrochemically active region 18, the first individual plates 2a have, on the front side thereof facing towards the viewer of FIG. 2, a flow field 17 with first structures 14 for guiding a reaction medium along the outer side (or also front side) of the individual plate 2a. In FIG. 2, these first structures 14 are defined by a plurality of webs and by channels extending between the webs and delimited by the webs. On the front side of the separator plates 2, facing towards the viewer of FIG. 2, the first individual plates 2a additionally each have at least one distribution and/or collection region 20. The distribution and/or collection region 20 comprises structures which are designed to distribute over the active region 18 a medium that is introduced from a first of the two through-openings 11b into the adjoining distribution region 20 and to collect or to pool, via the collection region 20, a medium flowing towards the second of the through-openings 11b from the active region 18. In FIG. 2, the distributing/collecting structures of the distribution and/or collection region 20 are likewise defined by webs and by channels extending between the webs and delimited by the webs.

The sealing beads 12a-12c are crossed by passages 13a-13c, which are in each case integrally formed in all the individual plates 2a, 2b, and of which the passages 13a are formed both on the underside of the upper individual plate 2a and on the upper side of the lower individual plate 2b and form a connection between the through-opening 11a and the distribution region 20, while the passages 13b in the upper individual plate 2a and the passages 13c in the lower individual plate 2b establish a corresponding connection between the through-opening 11b or 11c and the respectively adjoining distribution region 20. By way of example, the passages 13a enable coolant to pass between the through-opening 12a and the distribution and/or collection region 20, so that the coolant enters the distribution and/or collection region 20 between the individual plates 2a, 2b and is guided out therefrom.

Furthermore, the passages 13b enable hydrogen to pass between the through-opening 12b and the distribution or collection region on the upper side of the upper individual plate 2a; these passages 13b adjoin apertures 15 which face towards the distribution or collection region and which extend at an angle to the plate plane. Hydrogen, for example, thus flows through the passages 13b and the apertures 15 from the through-opening 12b to the distribution or collection region on the upper side of the upper individual plate 2a, or in the opposite direction. The passages 13c enable air, for example, to pass between the through-opening 12c and the distribution or collection region, so that air enters the distribution or collection region on the underside of the lower individual plate 2b or is guided out therefrom. The associated apertures extending in the bead flank are not visible here.

The first individual plates 2a each also have a further sealing arrangement in the form of a perimeter bead 12d, which extends around the flow field 17 of the active region 18 and also around the distribution and/or collection region 20 and the through-openings 11b, 11c and seals these off with respect to the through-openings 11a, that is to say with respect to the coolant circuit, and with respect to the environment surrounding the system 1. The second individual plates 2b each comprise corresponding perimeter beads 12d. The structures of the active region 18, the distributing or collecting structures of the distribution and/or collection region 20 and the sealing beads 12a-d are each formed in one piece with the individual plates 2a and are integrally formed in the individual plates 2a, for example in an embossing, hydroforming or deep-drawing process. The same applies to the corresponding flow fields, distributing structures and sealing beads of the second individual plates 2b. Each sealing bead 12a-12d may have in cross-section at least one bead top and two bead flanks, but a substantially angular arrangement between these elements is not necessary; a curved transition may also be provided, e.g. beads which are arcuate in cross-section are also possible.

While the sealing beads 12a-12c have a substantially round course, which nevertheless depends primarily on the shape of the associated through-opening 11a-11c, the perimeter bead 12d has various sections that are shaped differently. For instance, the course of the perimeter bead 12d may include at least two wavy sections.

The two through-openings 11b or the fluid-guiding lines through the plate stack of the system 1 that are formed by the through-openings 11b are in each case in fluid connection with each other via the passages 13b crossing the sealing beads 12b, via the distributing structures of the distribution or collection region 20 and via the flow field 17 in the active region 18 of the first individual plates 2a facing towards the viewer of FIG. 2. Analogously, the two through-openings 11c or the fluid-guiding lines through the plate stack of the system 1 that are formed by the through-openings 11c are in each case in fluid connection with each other via corresponding conveying channels, via corresponding distributing/collecting structures and via a corresponding flow field on an outer side of the second individual plates 2b facing away from the viewer of FIG. 2. To this end, respective channel structures 14 for guiding the relevant media are provided in the active regions 18.

In contrast, the through-openings 11a or the fluid-guiding lines through the plate stack of the system 1 that are formed by the through-openings 11a are in each case in fluid connection with each other via a cavity 19 which is surrounded or enclosed by the individual plates 2a, 2b. This cavity 19 serves in each case to guide a coolant through the bipolar plate 2, such as for cooling the electrochemically active region 18 of the separator plate 2. The coolant thus serves primarily to cool the electrochemically active region 18 of the separator plate 2. The coolant flows through the cavity 19 from an inlet opening 11a towards an outlet opening 11a. Mixtures of water and antifreeze are often used as coolants. However, other coolants are also conceivable. For better guidance of the coolant or cooling medium, channel structures are present on the inner side of the separator plate 2. These are not visible in FIG. 2 since they extend, for example, on the surface of the individual plate 2a facing away from the viewer; they are therefore situated opposite the above-mentioned channel structures 14 on the other surface of the individual plate 2a. In the active region 18, the channel structures guide the cooling medium along the inner side of the separator plate towards the outlet opening 11a.

While FIG. 2 shows a separator plate in which the perimeter bead does not surround the through-openings 11a, e.g. the perimeter bead is crossed by conveying channels of the passages 13a, designs of separator plates are also possible in which the through-openings 11a are surrounded by the perimeter bead in the same way as the other through-openings 11b, 11c, so that no such crossing is necessary. Mixed designs are also possible, in which, in addition to the perimeter bead shown in FIG. 2, a further perimeter bead is present, which surrounds all the through-openings 11a, 11b, 11c as well as any other media through-openings that may be present.

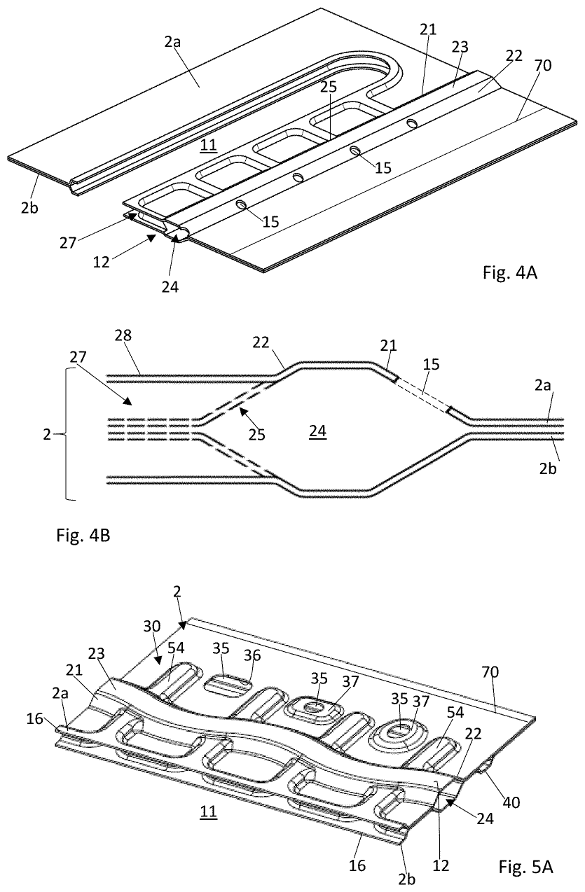

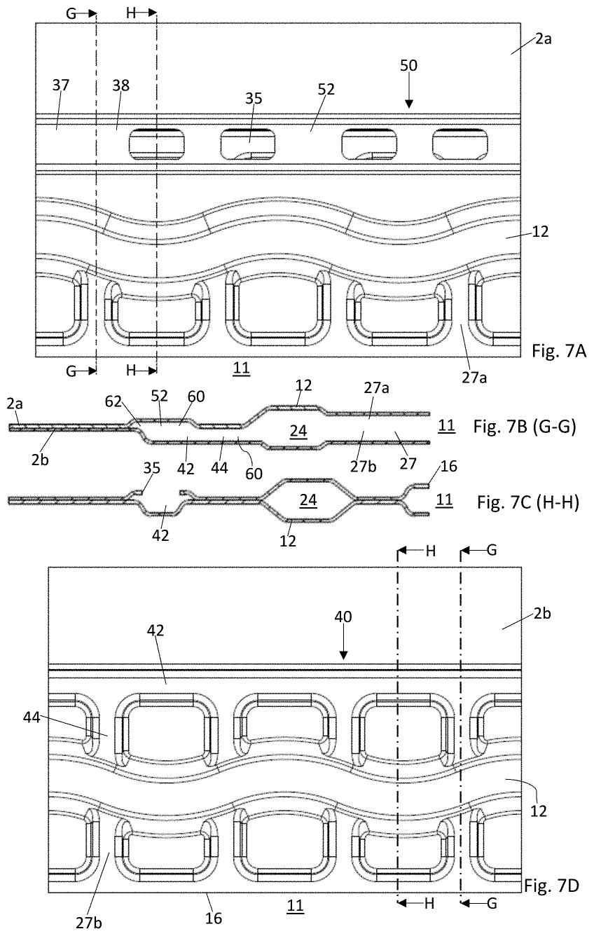

FIG. 3A shows, on a slightly enlarged scale, part of the separator plate 2 from FIG. 2 comprising the joined-together metal individual plates 2a, 2b. Facing towards the viewer is the front side of the first individual plate 2a. It is possible to see the through-openings 11a-c in the separator plate 2 and the sealing beads 12a-c arranged around the through-openings 11a-c for sealing off the through-openings 11a-c, said sealing beads being embossed into the first individual plate 2a. The sealing bead 12d for sealing off the active region 18 of the first individual plate 2a is shown in part. The sealing beads 12a-c again have passages 13a-c to enable media to pass through the sealing beads 12a-c or the bead arrangements 12 of the separator plate 2, it being clear that the medium of the through-opening 11a—which may be coolant—has to cross both the bead 12a and the bead 12d; said medium is continuously guided on the side of the individual plate 2a facing away from the viewer. The medium guided out of the through-opening 11b, between the individual plates 2a, 2b, and through the passage 13b transversely to the bead arrangement 12b passes through the aperture 15 extending in the flank (cf. for example the opening 33 in FIGS. 6 to 8 of the publication DE 20 2015 104 973 U1) and enters the distribution and/or collection region 20 facing towards the viewer. The medium discharged from the distribution and/or collection region on the opposite surface of the separator plate 2, which is not visible, passes through an opening formed in the second individual plate 2b and enters a conveying channel between the individual plates 2a and 2b, crosses the bead 12c via the passage 13c, and flows onwards into the through-opening 11c.

FIG. 3B shows, in a perspective view, part of a schematically illustrated separator plate 2, which is comparable to FIG. 3A apart from the shape of the through-opening. As representative but non-limiting, reference is made here to a through-opening 11, which can correspond to of the through-openings 11a-c, such as a through-opening corresponding to the through-opening 11c in FIG. 3A.

The first individual plate 2a may have a first sealing bead arranged around the through-opening 11 for sealing off the through-opening 11. The second individual plate 2b may accordingly have a second sealing bead arranged around the through-opening 11 for sealing off the through-opening 11. The first sealing bead and the second sealing bead may form the aforementioned bead arrangement 12 with the common sealing bead interior 24, which is fluidically connected to the through-opening 11 of the separator plate 2.

In the description below, also in relation to FIGS. 5-19, reference will usually be made, for the sake of simplicity, to the bead arrangement 12 and not to the individual sealing beads of the individual plates 2a, 2b.

The first sealing bead and the second sealing bead are typically formed on opposite sides of the separator plate 2 and usually point away from each other with their bead tops 23. The first sealing bead and the second sealing bead are usually designed as full beads and accordingly usually each comprise two bead flanks 21, 22. The bead flanks 21, 22 of the respective sealing beads are often connected by a bead top 23.

The bead flank 21 facing towards the through-opening 11 has a plurality of elevations 25 to enable a medium to pass through the bead flank 21, as well as conveying channels 27 adjoining said bead flank for conveying a medium to the bead flank 21. The through-opening 11 is in fluid connection with the bead interior 24 via the conveying channels 27 and the cutouts 25. The bead flank 22 facing away from the through-opening 11 likewise has elevations 25′ to enable a medium to pass through the bead flank 22.

The outer side of the bead arrangement 12, which faces away from the through-opening 11, is adjoined by conveying channels 26, which are in fluid connection with the bead interior 24 via elevations 25′. Here, the conveying channel 26 is designed such that a plurality of conveying channel sections open into a common distribution channel 29 extending substantially parallel to the bead arrangement 12, which distribution channel is likewise configured in the form of a bead and has apertures 15 arranged on the flank thereof facing away from the bead arrangement 12 and the through-opening 11. A medium guided in the media channel 11 can thus be guided through the bead arrangement 12 via the channels 27, the elevations 25, the bead interior 24, the elevations 25′, the channels 26, the distribution channel 29 and the apertures 15 and can be conveyed, for example, in a targeted manner into the active region 18 of the individual plate 2a or separator plate 2, as shown by the arrows in FIG. 3C. Between the bead arrangement 12 and the active region 18 (not shown here), the two individual plates 2a, 2b are connected to each other by means of a continuous or continuously acting weld seam 70. The conveying channels 26, 27 usually have a constant height, the height of the conveying channels 26, 27 of the individual plate 2a being given in each case by the distance, determined in the z-direction 7, of the tunnel top 28 from the flat surface plane E of the individual plate 2a. FIG. 3C shows a sectional view of the bead arrangement 12 according to FIG. 3B, wherein the section plane is oriented along the x-z plane and extends in the longitudinal direction through one of the conveying channels 26 or 27.

A reversal of the flow direction with respect to the through-opening 11 is achieved, for example, by the opposite side of the separator plate 2, where the fluid is conveyed from the active region 18, through the bead arrangement 12, to the through-opening 11.

FIGS. 4A and 4B show a variant of a bead arrangement 12 of the prior art, but in which, compared to FIG. 3, there is no conveying channel 26 or distribution channel 29 on the side facing towards the distribution region 20 or the active region 18, and already on the bead flank facing away from the through-opening 11 the medium flows through apertures 15 on the surface of the upper individual plate 2a facing towards the viewer. It is also possible for the elements 27, 25, 24, 15 to be reversed. In this case, which is not shown, the apertures 15 are located on a side of the bead arrangement 12 facing towards the through-opening 11a, while the channels 26 and 27 are arranged on a side of bead arrangement 12 facing towards the active region 18. In this case, the fluid therefore flows from the through-opening 11, successively through apertures 15, the bead interior 24, the elevations 25 and the channels 27, towards the active region 18.

The entire conveying sequence consisting of conveying channel 27, elevation 25, bead interior 24, elevation 25′, optional conveying channel 26, optional distribution channel 29, and aperture 15, corresponds to a bead passage 13 as mentioned above.

In order to make the stack 2 of the separator plates of the system 1 as compact as possible, it is desirable to form the bead arrangement 12 and the other sealing beads 12a-d of the separator plate 2 in as shallow a manner as possible. However, the apertures 15 and elevations 25 in the bead flanks 21 may impair the stability and elasticity and thus the sealing effect of the bead arrangement 12. This could possibly be remedied by reducing the size of the apertures 15 and elevations 25. However, such a reduction in size would result in a likewise undesired reduction in the flow of medium through the bead arrangement 12.

In addition, the individual plates 2a, 2b of the separator plate 2 are often first embossed, hydroformed or deep-drawn before the apertures 15 are punched or cut into the individual plates. As a result, relatively complicated 3D cuts are required in order to form the apertures 15. Since the edges of the apertures 15 are sometimes arranged relatively high up in the stacking direction, there is also the risk that the MEA 10 resting on the bead top 23, such as the frame-like reinforcing layer or reinforcing frame of the MEA, will be damaged by sharp edges of the apertures 15.

The present disclosure has been conceived to solve, at least in part, the problems mentioned above.

Various embodiments of the present disclosure are shown in the groups of FIGS. 5-18, each group comprising sub-figures which show different views and sectional diagrams. For the sake of clarity, reference will sometimes be made to an entire group of figures (for example FIG. 5 instead of one of FIGS. 5A-5G).

The embodiments of FIGS. 5-18 comprise a separator plate 2 for an electrochemical system 1, comprising a first individual plate 2a and a second individual plate 2b, which are connected to each other, for example by welded joints, such as laser-welded joints. The separator plate 2 may have the above-described electrochemically active region 18. FIGS. 5-18 show a region around a through-opening 11 of a separator plate 2 with bead passages 30 through the bead arrangement 12.

The separator plate 2 further comprises at least one through-opening 11 for the passage of a fluid, and a bead arrangement 12 arranged around the through-opening 11 for sealing off the through-opening 11, wherein a bead interior 24 of the bead arrangement 12 is fluidically connected to the through-opening 11 of the separator plate 2. Hereinbelow, the through-opening 11 can represent one of the through-openings 11a-11c mentioned above. Furthermore, the bead arrangement 12 can represent one of the sealing beads 12a-c. By means of the bead passages 30, the fluid can be conveyed from the through-opening, through the bead arrangement 12, to the active region 18, or from the active region 18, through the bead arrangement 12, to the through-opening 11.

The separator plate 2 additionally has at least one first aperture 35 formed in the first individual plate 2a, which aperture extends substantially parallel to a plate plane defined by the separator plate. In other words, a plane defined by the aperture 35, or more precisely by a circumferential edge 36 of the aperture 35, is substantially parallel to the plate plane of the separator plate 2.

The first aperture is therefore not formed in a bead flank 22 of the bead arrangement 12 that extends at an angle to the plate plane, or in a curved section of the separator plate, such as an end section of a conveying channel. Due to the fact that the plane defined by the aperture 35 is parallel to the plate plane, a simple 2D cut can be made when creating the aperture 35 or apertures 35. The parallel orientation of the aperture 35 also reduces the risk of damage to the reinforcing frame of the MEA 10.

In order that the aperture 35 of the first individual plate 2a is still fluidically connected to the bead arrangement 12, the separator plate 2 additionally comprises at least one conveying channel 40 formed in the second individual plate 2b, which conveying channel is arranged on a side of the bead arrangement 12 facing away from the through-opening 11. The conveying channel 40 formed in the second individual plate 2b opens into a region of the first individual plate 2a containing the first aperture 35. The conveying channel 40 formed in the second individual plate 2a also fluidically connects the bead interior 24 of the bead arrangement 12 to the first aperture 35 formed in the first individual plate 2a.

The conveying channel 40 may be formed or bounded by the plate material of the second individual plate 2b. The conveying channel 40 is usually integrally formed in the second individual plate 2b by hydroforming, roller embossing, vertical embossing and/or deep-drawing, and as such may be trough-shaped. It may be provided that, at least in some regions, the conveying channel 40 extends from the second sealing bead in the direction of the electrochemically active region 18. As shown in FIG. 5, for example, the conveying channel in this case ends before the weld seam 70, which may be present in separator plates 2 according to the present disclosure in the same way as in the prior art. In most exemplary embodiments, the weld seams have been omitted for reasons of clarity. The conveying channel 40 may adjoin the second sealing bead, such as a bead flank of the second sealing bead.

It should be noted here that the fluidic connection of the bead interior 24 to the first aperture 35 by means of the conveying channel 40 may be established directly or at least indirectly. Between the conveying channel 40 and the bead interior 24, therefore, there may also be further channel sections or connection pieces which fluidically connect the conveying channel to the bead interior 24.

The conveying channel 40 may also comprise various sections 42, 44 with different orientations or directions of extension, cf. embodiments of FIGS. 5-11, 13 and 15-18. For example, the conveying channel 40 may comprise at least or exactly one primary channel 42, which by way of example, but not necessarily, extends substantially parallel to a main direction of extension (see below) of the bead arrangement 12 and/or parallel to the edge 16 of the through-opening 11. The primary channel 42 is typically spaced apart from the bead arrangement 12 and is located on the side of the bead arrangement 12 facing towards the active region. The primary channel 42 often has a straight course, but it may also be wavy or arcuate in some regions. A cross-section of the primary channel 42 transverse to the course of the primary channel 42 and through the second individual plate 2b is usually trapezoidal.

The conveying channel 40 may further comprise at least one secondary channel 44, for example a plurality of secondary channels 44. Hereinbelow, reference is made to a single secondary channel 44; of course, this may also mean a plurality of secondary channels 44. The secondary channel 44 may fluidically connect the primary channel 42 to the bead interior 24 and usually adjoins the bead flank 22 of the bead arrangement 12, or more precisely the bead flank of the second sealing bead formed in the second individual plate 2b. If the associated through-opening 11 is designed as an inlet opening, the primary channel 42 is thus fed by the secondary channels 44. Conversely, if the associated through-opening 11 is designed as an outlet opening, the primary channel 42 is a feed line for the secondary channels 44. Depending on the direction of flow of the fluid and the function of the through-opening 11, the primary channel 42 can be referred to as a distribution channel or collection channel. For instance, the sections 42 and/or 44 or the conveying channel 40 are lower than the bead arrangement 12, e.g. they project out of the plate plane by a smaller distance than the bead arrangement 12.

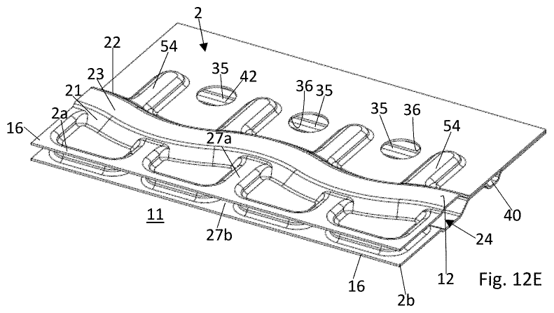

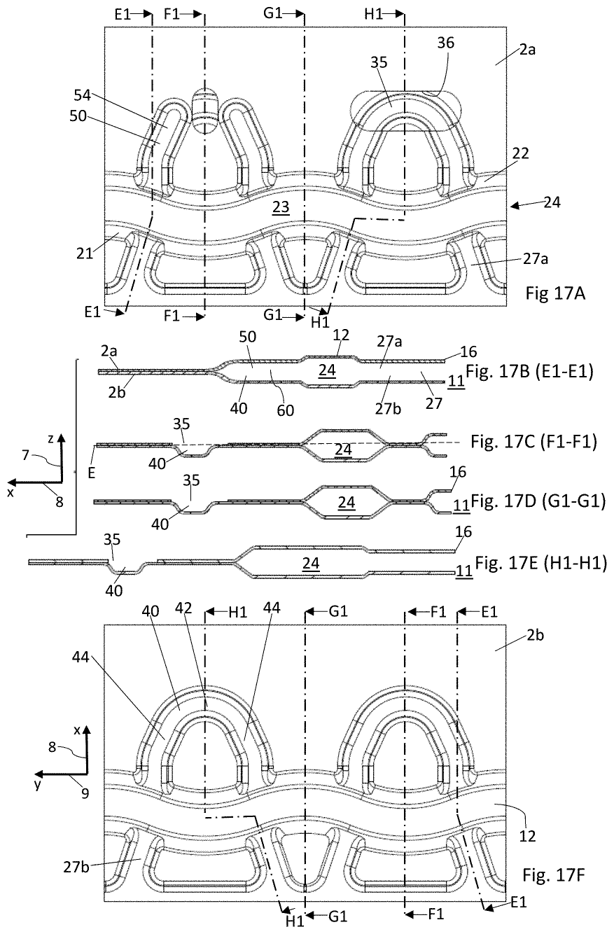

The secondary channel 44 may be arranged at an angle to the primary channel 42 and/or to the main direction of extension of the bead arrangement 12, for example at an angle α of at least 45°, for example at least 60°, for instance at least 75° and/or at most 135°, for example at most 120°, for example at most 105°. In one example, the secondary channel 44 extends substantially orthogonally to the primary channel 42 and/or to the main direction of extension of the bead arrangement 12. The secondary channel 44 usually extends from the bead arrangement 12 in the direction of the active region 18. FIG. 17 shows an exemplary embodiment, where the secondary channels 44 in their straight sections extend at an angle of about 55° relative to the short straight section of the primary channel 42. FIG. 12 shows an exemplary embodiment in which one primary channel 42, but no secondary channel 44, is present.

The first aperture 35 is usually spaced apart from the bead arrangement 12. The aperture 35 may be formed, for example, in a region of the first individual plate 2a that lies in a plate plane of the first individual plate 2a, cf. sectional views in FIGS. 5D, 8C, 9C, 10C, 11B, 12C, 13C, 15D 16D, 17D and 18B. The plate plane of the individual plate 2a may be defined here as the flat region of the individual plate 2a that is not embossed.

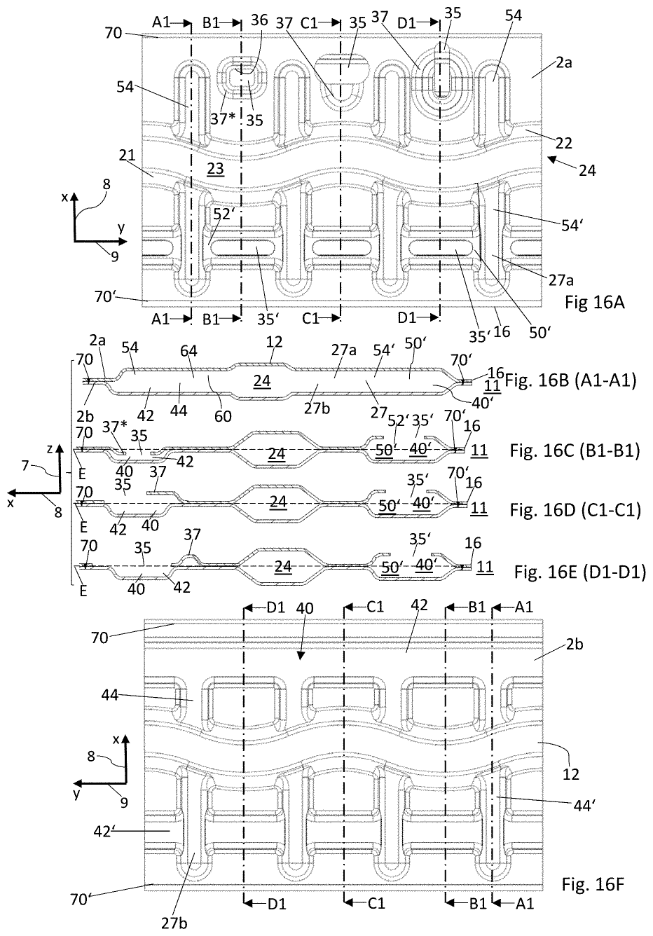

Alternatively, the first aperture 35 may be formed in an embossed region 37 of the individual plate 2a. Such a design is shown in the sectional views of FIGS. 5E, 5F, 6C, 7C, 14C, 16C, 16D, 16E. In any case, in the immediate vicinity of the first aperture 35, e.g. in the region adjoining the first aperture 35, the embossed region 37 is shallow and parallel to the plate plane of the first individual plate 2a, in the case of a bead-like embossing (FIG. 16E) optionally identical to the plate plane of the first individual plate 2a, and parallel to the plate plane E of the separator plate 2. The embossed region 37 may have a height, measured perpendicularly from the plate plane, which is smaller than a height of the bead arrangement 12, so that the embossed region 37 is not compressed in the assembled state of the stack 1. It can be seen from FIG. 5B in combination with FIGS. 5E and 5F that the embossed regions 37 may have different heights. Furthermore, FIGS. 16D and 16E show that it is also possible that, in some sections, the embossment surrounds the aperture 35 at a distance therefrom, while at least in some sections the edge 36 of the aperture 35 extends in the plate plane. This enables better support for the MEA reinforcing frame, without impairing the flow of media.

In the embodiment of FIG. 5, the embossed regions 37 are formed around the apertures 35 and may have, for example, a rounded-rectangular basic shape or an oval basic shape. Each embossed region has a single aperture 35. The embossed region 37 can also be understood as an embossed structure. While the embossed regions 37 in the middle and on the right in FIG. 5A project out of the plate plane in the same direction as the bead arrangement 12, the embossed region 37* on the left in FIG. 16A is embossed in the opposite direction to the direction of the bead arrangement relative to the plate plane; it therefore projects into the conveying channel 42, as can be seen from FIG. 16C.

In the embodiments of FIGS. 6A, 7A, 14A, a plurality of apertures 35 are provided per embossed region 37. For example, the embossed region 37 may be designed as a channel-shaped raised region, when viewed from the contact plane E of the individual plates, and may have a flat top 38 which extends parallel to the plate plane of the separator plate 2. In addition, the embossed region 37 of the first individual plate 2a in these embodiments may extend, for example, in a channel-like manner along the conveying channel 40 of the second individual plate 2b. Here, the embossed region 37 is designed, for example, as a primary channel 52 (see below) of the first individual plate 2a.

An orthogonal projection of the first aperture 35 perpendicular to the plate plane onto the second individual plate 2b may define a projection area, wherein the second individual plate 2b has at least part of the conveying channel 40 in the region of the projection area. This may be evident in a plan view of the first individual plate 2a and their first apertures 35, cf. FIGS. 5B, 6A, 7A, 8A, 9A, 10A, 11A, 12A, 12E, 13A 15A, 17A and 18A, where the conveying channel 40, for example the primary channel 42, can be clearly seen beneath the aperture 35.

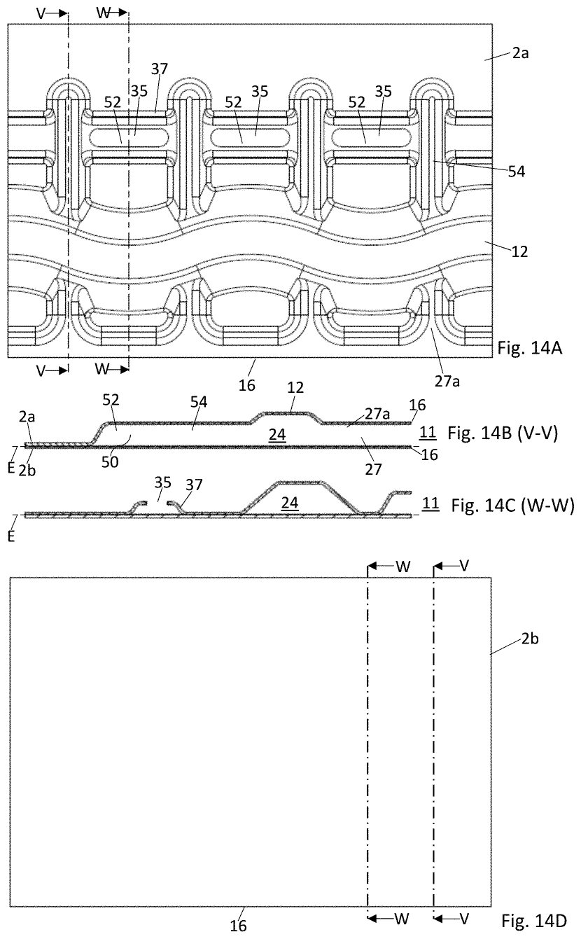

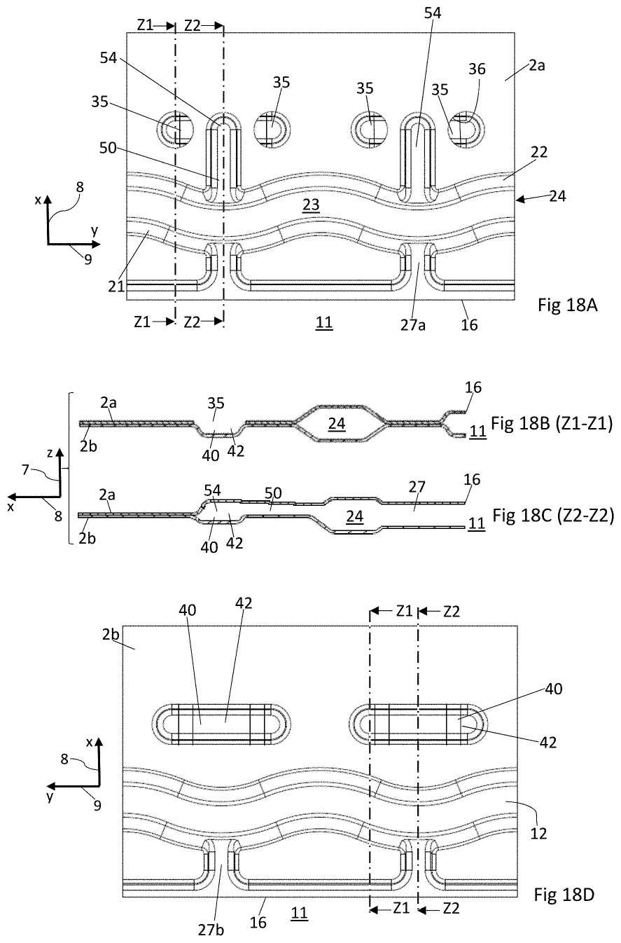

Although the separator plates 2 shown in FIGS. 5-13 and 15-17 have the primary channel 42, and in FIG. 18 a plurality of primary channels 42, it is alternatively also possible to omit the primary channel 42. In this case, each aperture 35 may be assigned its own secondary channel 44, which fluidically connects the respective aperture 35 to the bead interior 24. By suitably designing the conveying channel 50 in the first individual plate 2a, which is yet to be described below, it is also possible to omit a primary channel 42 in the second individual plate 2b, as shown in FIG. 14.

In some embodiments, the separator plate 2 comprises at least one conveying channel 50 formed in the first individual plate 2a, which conveying channel is arranged on a side of the bead arrangement 12 facing away from the through-opening 11 or on the side of the bead arrangement 12 facing towards the active region 18. The conveying channel 50 formed in the first plate 2a may be in direct or indirect fluid connection with the bead interior 24 of the bead arrangement 12.

The conveying channel 50 may be formed by the plate material of the first individual plate 2a. The conveying channel 40 is usually integrally formed in the second individual plate 2a by hydroforming, roller embossing, vertical embossing and/or deep-drawing and as such may be configured as a bead, such as a full bead. It may be provided that, at least in some regions, the conveying channel 50 extends from the first sealing bead in the direction of the electrochemically active region 18. The conveying channel 50 may adjoin the first sealing bead, such as a bead flank of the first sealing bead.

The conveying channel 50 may therefore comprise various sections 52 and/or 54 with different orientations or directions of extension, cf. embodiments of FIGS. 5-8, 11, 12, 14, 15, 16, 17 and 18. For example, the conveying channel 50 may have a primary channel 52 and/or at least one secondary channel 54 in a manner analogous to the primary and secondary channels 42, 44 of the conveying channel 40. The sections 52 and/or 54 or the conveying channel 50 may be lower than the bead arrangement 12, e.g. they project out of the plate plane by a lesser distance than the bead arrangement 12.

The conveying channel 50 may comprise, for example, a single primary channel 52, cf. FIGS. 6A, 7A, 14A, which by way of example, but not necessarily, extends substantially parallel to a main direction of extension (see below) of the bead arrangement 12 and/or parallel to the edge 16 of the through-opening 11. The primary channel 52 is typically spaced apart from the bead arrangement 12 and is located on the side of the bead arrangement 12 facing towards the active region. The primary channel 52 often has a straight course.

The at least one aperture 35 may be formed in a flat section of the conveying channel 50 formed in the first individual plate 2a, for example in a flat top of the conveying channel. For instance, the aperture 35 may be formed in a flat section of the primary channel 52, for example in a top 38 of the primary channel 52.

In some embodiments (cf. FIGS. 5B, 6A, 8A, 11A, 12A, 14A, 16A, 17A 18A), the conveying channel 50 may also have at least one secondary channel 54, for instance a plurality of secondary channels 54. Hereinbelow, reference will be made to a single secondary channel 54; however, it is clear that this may also mean a plurality of secondary channels 54.

In some embodiments (cf. FIGS. 6A, 14A), the secondary channel 54 fluidically connects the primary channel 52 to the bead interior 24 and often adjoins the bead flank 22 of the bead arrangement 12, or more precisely the bead flank of the first sealing bead formed in the first individual plate 2a. If the associated through-opening 11 is designed as an inlet opening, the primary channel 52 is thus fed by the secondary channels 54. Conversely, if the associated through-opening 11 is designed as an outlet opening, the primary channel 52 is a feed line for the secondary channels 54.

The secondary channel 54 may be arranged at an angle to the primary channel 52 and/or to the main direction of extension of the bead arrangement 12 and/or to the edge 16 of the through-opening, for example at an angle β of at least 45°, for example at least 60°, at least 75° and/or at most 135°, for example at most 120°, at most 105°. In one example, the secondary channel 54 extends substantially orthogonally to the primary channel 52 and/or to the main direction of extension of the bead arrangement 12 and/or the edge 16 of the through-opening 11. The secondary channel 54 usually extends from the bead arrangement 12 in the direction of the active region 18.

The secondary channels 54 may extend so far in the direction of the first apertures 35 that, at least in some sections, such as with those regions in which they have their maximum height, they project between the first apertures or even to a greater distance away from the bead arrangement and thus can support the MEA reinforcing frame, so that a sufficient flow space to or from the aperture 35 to the active region 18 is ensured, cf. FIGS. 5, 6, 8, 11, 12, 13, 14, 16, 17, and 18.

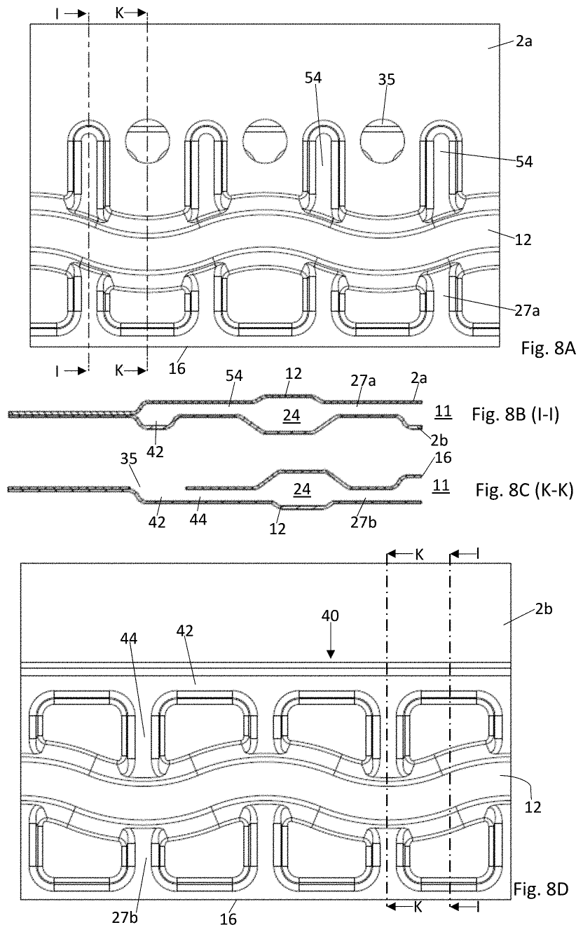

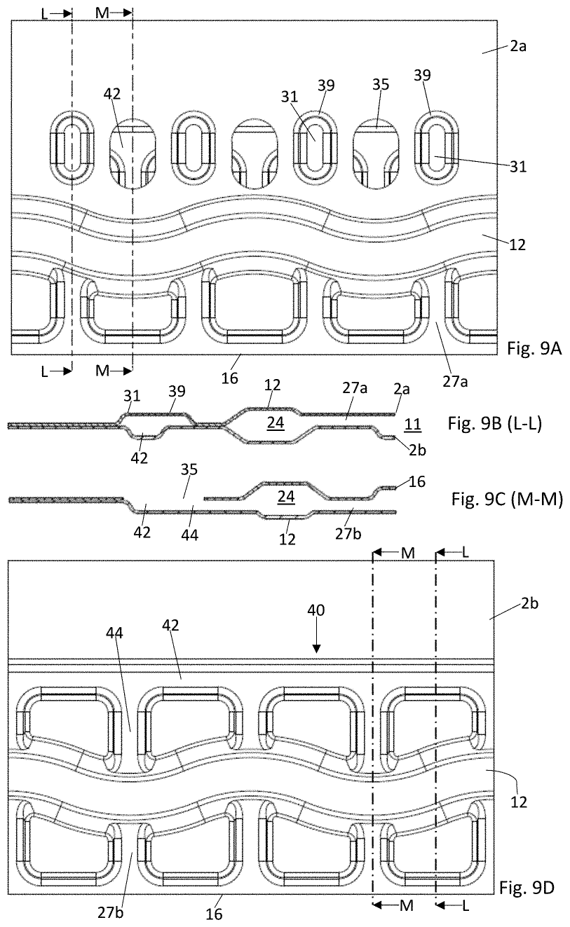

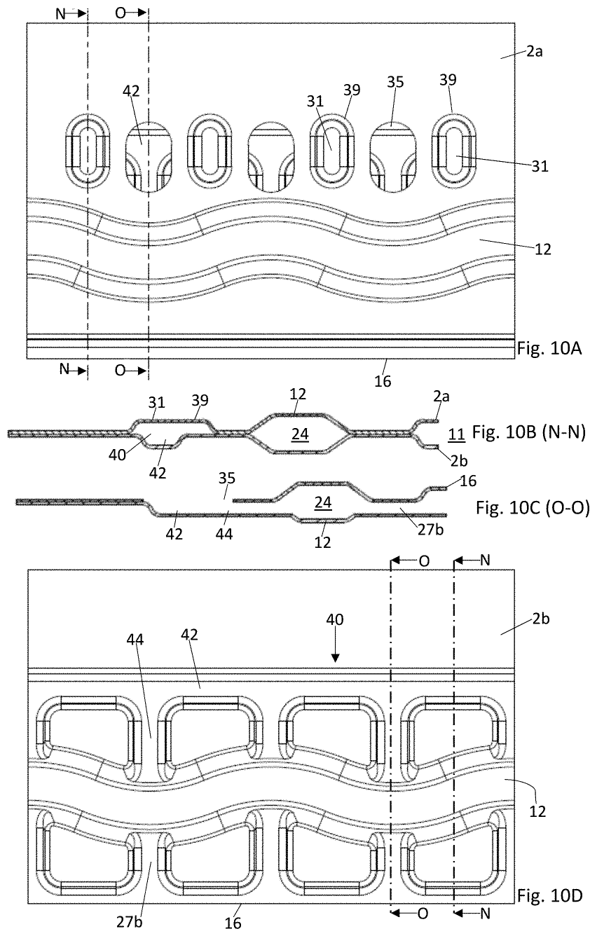

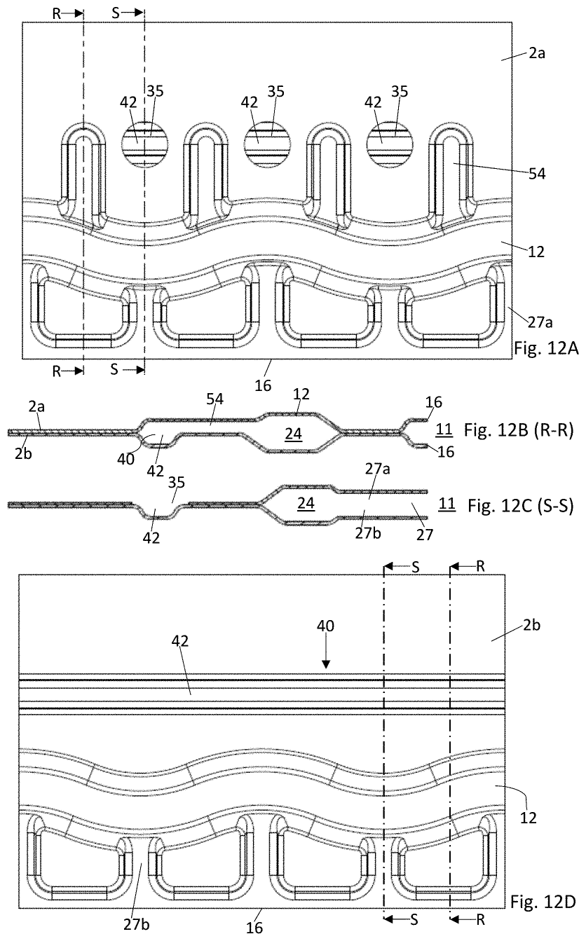

It should be noted at this point that the conveying channel 50 and the channels 52, 54 are optional. The channels 50, 52, 54 are therefore not present in some embodiments, cf. FIGS. 9, 10, 15. The conveying channel 50 may comprise only the primary channel 52 (cf. FIG. 7) or the at least one secondary channel 54 (cf. FIGS. 5, 8, 11, 12, 18). Alternatively, both the primary channel 52 and the secondary channels 54 may be provided, cf. FIGS. 6, 14. The primary channels 52 may extend offset from each other in relation to the conveying sections 42 in orthogonal projection in the plate plane, cf. FIGS. 8 and 11, or may substantially overlap each other, cf. FIGS. 5, 6 and 13.

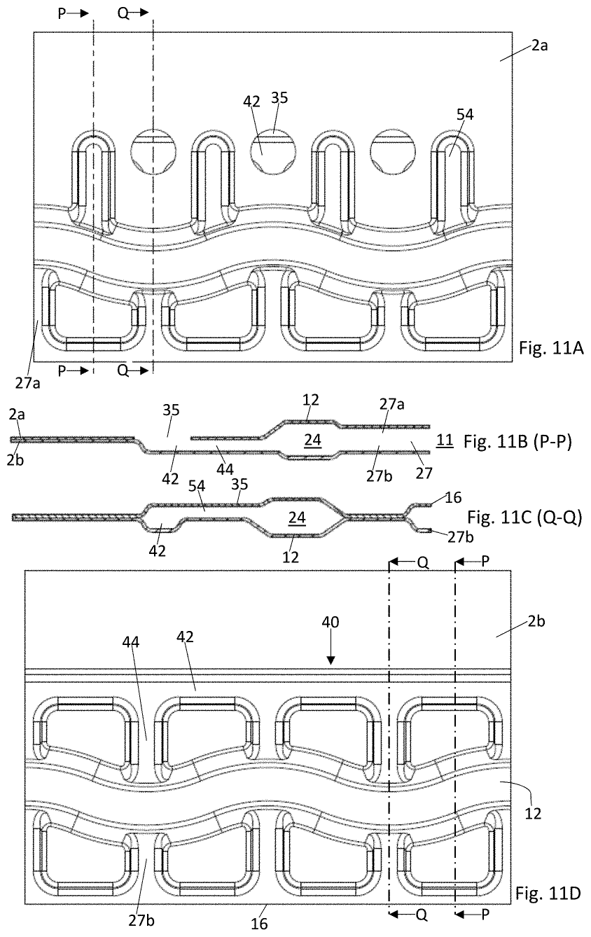

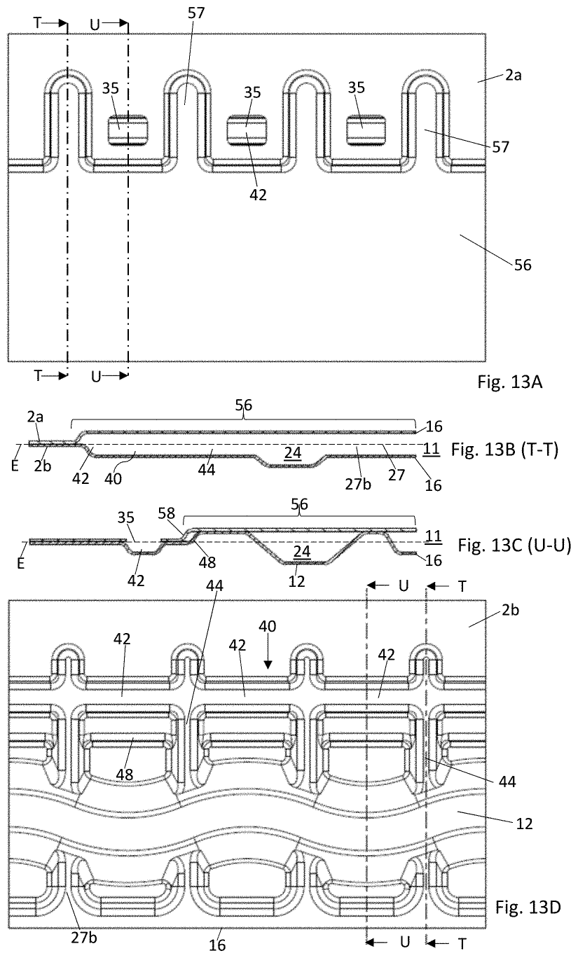

As already indicated above, conveying channels 27 may optionally be present on a side of the bead arrangement 12 facing towards the through-opening 11 (cf. FIGS. 5-14 and 16-18), which conveying channels are usually each of constant height and constant width and open into the through-opening 11. The conveying channels 27 may in this case be formed only in the first individual plate 2a (FIG. 14), only in the second individual plate 2b (FIGS. 10, 13), or in both individual plates 2a, 2b (FIGS. 5, 6, 7, 8, 9, 11, 12, 16, 17, 18). By way of example, FIGS. 9 and 10 differ from each other in that conveying channels 27a, 27b are formed on both sides of the separator plate in FIG. 9, while in FIG. 10 only the second individual plate 2b has conveying channels 27b. In FIGS. 8, 9, the conveying channels 27a, 27b of the individual plates 2a, 2b are arranged offset from each other in a direction parallel to the edge 16, so that they do not overlap with each other and extend parallel to each other perpendicularly to the edge 16. In other embodiments, the conveying channels 27a, 27b are provided in both plates 2a, 2b and are arranged so as to overlap, cf. FIGS. 5C, 6B, 7B, 11B, 12C, 16B, 17B, 18C so that together they form conveying channels 27 of the separator plate.

The conveying channels 27, 27a, 27b adjoin a bead flank 21 of the bead arrangement 12—or bead flanks of the first sealing bead and/or of the second sealing bead—and form a fluidic connection between the through-opening 11 and the bead interior 24. The feeding of a medium from the through-opening 11 to the bead arrangement 12 can thus take place by means of such conveying channels 27, 27a, 27b. Such conveying channels 27, 27a, 27b can also improve the discharging of the medium from the bead arrangement 12 to the through-opening 11.

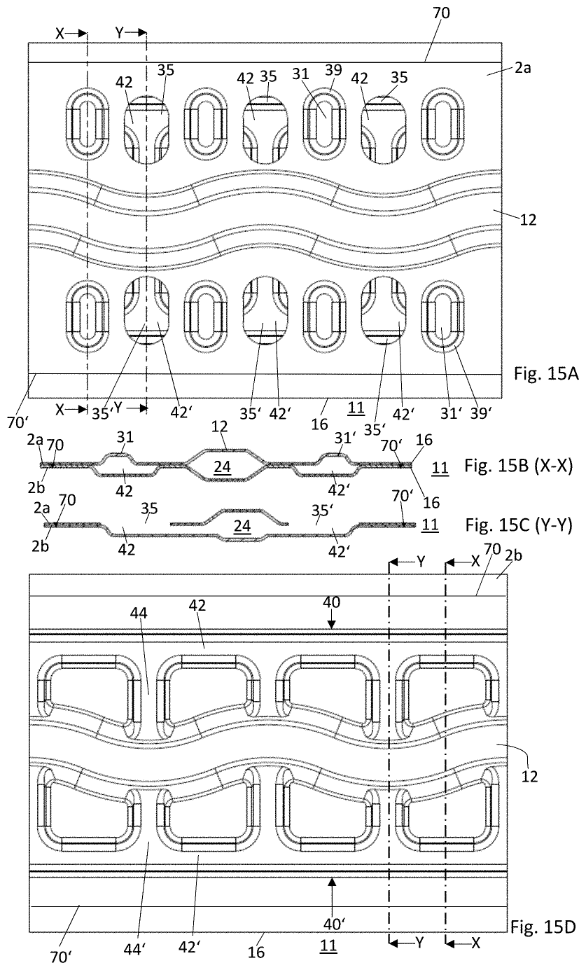

Alternatively, as shown in FIG. 15, it is possible that the passage of media between the through-opening 11 and a conveying channel 40′ leading to the bead interior 24 does not take place between the individual plates 2a, 2b, but rather via a further aperture 35′ or a plurality of further apertures 35′ in one of the individual plates 2a, 2b, here the individual plate 2a. This may be advantageous if a weld seam 70′ is also provided between the sealing bead 12 and the through-opening 11, for example in order to prevent or limit the moving-apart of the layer edges surrounding the through-opening 11 when the sealing bead 12 is compressed.

It is also possible to provide an aperture 35′ on the side of the sealing bead 12 facing towards the through-opening 11, too, as is the case in FIG. 16. Here, a weld seam 70′ is also arranged between the sealing bead 12 and the through-opening 11, which weld seam extends around the through-opening 11 so that fluid between the bead interior 24 and the through-opening 11 can flow only through the apertures 35′. The apertures 35′ themselves are arranged in a plane parallel to the plate plane, said plane being formed by the channel 50′ or primary channel 52′. The primary channel 52′ connects the apertures 35′ and the secondary channels 54′, which within the first individual plate 2a in turn establish the connection to the bead interior 24. Also formed in the second individual plate 2b, on the side of the bead facing towards the through-opening 11, is a channel 40′ with a primary channel 42′ and secondary channels 44′, said channel being arranged substantially as a mirror image in relation to the aforementioned channel 50′, but without the apertures 35′.

It would also be possible to omit an aperture 35 on the side of the sealing bead 12 facing away from the through-opening 11; this may be advantageous if the medium, as is customary in the case of coolant for example, does not flow on an outwardly facing surface of the separator plate 2 in the active region 18, but instead flows in the interior between the individual plates 2a, 2b and therefore does not have to pass through any of the individual plates 2a, 2b on the side of the sealing bead 12 facing towards the active region 18. Features shown in connection with the apertures 35 shown in FIGS. 5-14 and 16-18 can also be combined and claimed with the apertures 35′. For example, in analogy to FIG. 5B, channels or channel sections 50, 52 and/or 54 may be provided in the first separator plate 2a between the bead arrangement 12 and the edge 16 of the through-opening 11.

The provision of secondary channels 44 may be advantageous if the conveying channels 27b are also arranged on the side of the bead arrangement 12 facing towards the through-opening 11. Accordingly, the provision of secondary channels 54 may also be advantageous if conveying channels 27a are also arranged on the side of the bead arrangement 12 facing towards the through-opening 11. By way of example, both channels 27a, 54 and 27b, 44 are provided on both sides of the bead arrangement 12 in the exemplary embodiments of FIGS. 5, 6, 8, 11, 16 and 17, as a result of which a compression force on the bead arrangement 12 can be made more homogeneous or can be homogenized. This in turn has an advantageous effect on the leaktightness of the system.

The provision of the primary channel 52 may be advantageous, for example, if embossed inner edges 16 of the through-opening 11 are present on the side of the bead arrangement 12 facing towards the through-opening 11, as is the case symmetrically in FIGS. 5-12 and 17-18 and asymmetrically in FIGS. 13 and 14. A compression force on the bead arrangement 12 can thus be made more homogeneous or can be homogenized. This in turn has an advantageous effect on the leaktightness of the system.

The conveying channels 40, 50 of the individual plates 2a, 2b may overlap at least in some regions and at these points, they can together form a conveying channel 60 of the separator plate 2. Overlapping primary channels 42, 52 of the individual plates 2a, 2b may therefore be parts of a primary channel 62 of the separator plate 2. In some embodiments, a secondary channel 64 of the separator plate 2 is provided, which is formed by overlapping secondary sections 44, 54 of the individual plates 2a, 2b, cf. FIGS. 5C, 6B, 16B.

The secondary channels 44, 54 of the individual plates are sometimes offset from each other, so that they do not form a common secondary channel 64, but instead form spatially separate channel sections, cf. for example FIGS. 8 and 11. This may have an equalizing effect on the stiffness curve of the bead arrangement.

The through-openings 11 of the individual plates 2a, 2b each optionally have embossed inner edges 16 extending therearound, which edges point away from each other and/or are spaced apart from each other, cf. FIGS. 5-12 and 17-18. An inlet—when the through-opening 11 is designed as an inlet opening—or an outlet—when the through-opening 11 is designed as an outlet opening—of the at least one conveying channel 27, which inlet or outlet points towards the through-opening 11, is usually formed at the embossed inner edge 16 of the through-opening, wherein the conveying channel 27 or conveying channel 27a, 27b and the embossed inner edge 16 usually have an equal height, measured perpendicular to a flat surface plane (plate plane) of the separator plate 2. These embossed inner edges 16, or more precisely the embossed regions directly adjoining the inner edges 16, may be advantageous with regard to forming the conveying channels 27, 27a, 27b and punching or cutting the through-openings 11 in one plane. In FIG. 14, the embossment of the inner edge 16 is formed only in the first individual plate 2a, but in terms of its height corresponds approximately to the sum of the height of the embossments of the two individual plates 2a, 2b in the exemplary embodiments of FIGS. 5-12 and 17-18.

In the exemplary embodiment of FIG. 13, a much broader region adjoining the inner edge 16 or the through-opening 11 is deformed out of the plate plane in the first individual plate 2a than in the other exemplary embodiments and forms a raised region 56 which projects in a finger-like manner in the direction of the active region 18. The finger-like projections 57 overlap with the conveying channel 40 and the apertures 35 in the second individual plate 2b and thus together with the conveying channel 40 establish a fluid connection between the apertures 35 and the bead interior 24 and also with the through-opening 11. The finger-like projections 57 and the raised region 56 may therefore be provided instead of the primary channels 54 and the conveying channels 27a. The finger-like projections 57 here also serve as embossments, which extend between the apertures 35 and this way support the MEA reinforcing frame.

FIGS. 5A, 5B show various apertures 35 which have different shapes: rectangular with rounded corners, circular and oval. The present disclosure is not limited to these shapes of apertures 35; instead, other shapes can also be used for the apertures 35, for example slot-shaped (cf. FIGS. 9, 10) or rounded-polygonal.

The first individual plate 2a may sometimes also have embossed structures 39, which are spaced apart from the bead arrangement 12 and the apertures 35. The embossed structures 39 are shown, for example, in FIGS. 9 and 10 and, like the embossed regions 37 of FIG. 5, may be curved with a flat top 31, but they do not have any apertures 35. The embossed structures 39 may be provided instead of the primary channels 54 and act as a local stiffening of the first individual plate 2a. These embossed structures, when arranged between apertures 35, also act as spacers, so that the MEA reinforcing frame does not bear directly against the apertures 35 and the fluid can flow unhindered from or to the apertures 35. The embossed structures 39 may be arranged above the conveying channel 40, such as the primary channel 42. An orthogonal projection of the embossed structure 39 perpendicular to the plate plane onto the second individual plate 2b may define a projection area, wherein the second individual plate 2b has at least part of the conveying channel 40, such as part of the primary channel 42, in the region of the projection area. For instance, the embossed structure 39 bridges over the conveying channel 40 or the primary channel 42 at least in the x-direction and thus gives the overall system more structural rigidity.

FIGS. 6A and 6B show that the primary channel 52 and the secondary channel 54 each have a different height, measured perpendicular to a flat surface plane (plate plane) of the separator plate 2 or the first individual plate 2a. Alternatively, they may also have an equal height in a manner analogous to the primary and secondary channels 42, 44 of the second individual plate 2b.

The conveying channel 27b formed in the second individual plate 2b and the secondary channel 44 often have an equal height, measured perpendicular to a flat surface plane (plate plane) of the separator plate 2b or the second individual plate 2b, cf. FIGS. 5C, 6B, 7B, 8C, 9C, 10C, 11B, 13B and 16B. The equal heights of the channels 27b, 44 result in an even area around the bead arrangement 12, which has a positive effect on the sealing behavior of the bead arrangement. Alternatively, the channels 27b, 44 may also have different heights. The primary channel 42 and the secondary channel 44 usually have an equal height, measured perpendicular to a flat surface plane (plate plane) of the separator plate 2 or the second individual plate 2b, cf. FIGS. 5C, 6B, 7B, 8C, 9C, 10C, 11B, 13B and 16B. Alternatively, the channels 42, 44 may also have different heights. The channels may also have heights that vary along their course, as shown in FIG. 18B, where the height reduces towards the edges, starting in the overlap area with the apertures 35.

In the embodiment of FIG. 6, the primary channel 52 and the secondary channel 54 have a different height, measured perpendicular to a flat surface plane (plate plane) of the separator plate 2 or the first individual plate 2a. For example, the height of the secondary channel 54 is greater than the height of the primary channel 52. Alternatively, the height of the primary channel 52 may be greater than the height of the secondary channel. According to another embodiment, the channels 52, 54 may have an equal height.

The conveying channel 27a formed in the first individual plate 2a and the secondary channel 54 often have an equal height, measured perpendicular to a flat surface plane (plate plane) of the separator plate 2 or the second individual plate 2b, cf. FIGS. 5C, 6B, 8B, 14B and 16B. The equal heights of the channels 27a, 54 result in an even area around the bead arrangement 12, which has a positive effect on the sealing behavior of the bead arrangement. Alternatively, the channels 27a, 54 may also have different heights.

In a section located between the through-opening 11 and the active region 18, the bead arrangement 12 may have a periodic course, such as a wavy course with concave and convex sections, cf. FIGS. 5-18. The convex and concave sections of the wavy course in each case merge into each other at a turning point. A main direction of extension is superimposed on the wavy shape of the bead top 23. The main direction of extension of the bead arrangement 12 then results from the line connecting the turning points of the neutral axis of the bead top 23. In alternative embodiments, the course of the bead arrangement 12 has a straight course in the section located between the through-opening 11 and the active region 18, as shown for the prior art in FIG. 4A, but this can also be implemented for the present disclosure. In this case, the main direction of extension corresponds to the straight course of the bead top 23.

The apertures 35 may face towards convex and/or concave sections of the bead arrangement 12. Each aperture 35 may be arranged between two adjacent secondary sections 54 or embossed structures 39. The apertures 35 may be spaced apart from each other at regular intervals, cf. FIGS. 6A, 8A, 9A, 10A, 11A, 12A, 13A, 14A, 15A and 18. In the penultimate figure mentioned, this also applies to the apertures 35′ facing towards the through-opening 11. In the embodiment of FIG. 7A, the intervals between the apertures 35 vary.

The exemplary embodiments of FIGS. 13 and 14 differ from the other exemplary embodiments in that, in each of these figures, a sealing bead 12 is formed in just one of the individual plates 2a, 2b. The bead heights here are higher than in the other exemplary embodiments. In FIG. 13, the bead is asymmetrical in relation to the plane E of the separator plate 2 such that the bead top thereof projects downwards beyond the plane E, while the bead feet project upwards beyond the plane E. This upwardly projecting height is equalized by an additional step 48 in the second individual plate 2b, said additional step being arranged between the sealing bead 12 and the aperture 35. A corresponding additional step 58 is also integrally formed in the first individual plate 2a. In contrast, in FIG. 14, the bead is designed such that it projects substantially entirely upwards beyond the plane E; when considering the lower surface of the sheet metal layer of the individual plate 2b, and not the neutral axis thereof, only the bead feet are situated in the plane E. The exemplary embodiment of FIG. 14 thus shows that it is also possible to design the separator plate 2 according to the present disclosure in such a way in the sealing region that only the individual plate 2a is embossed, while the individual plate 2b can be embodied as a smooth sheet in the corresponding region, with no embossments, depressions or raised regions.

One aperture 35 may be fluidically connected to two conveying channels 40 that terminate in the vicinity thereof, as shown in FIG. 17.

A group of two apertures 35 may be fluidically connected via a short conveying channel 40 or 42 to a terminating conveying channel 54, as shown in FIG. 18A. FIG. 18C further shows that the top of a conveying channel, here the conveying channel 54, does not have to extend parallel to the plate plane, but rather may also extend at an angle on the other side of bead flanks and other flanks, for example an angle of <30°.

It is clear to a person skilled in the art that individual features of FIGS. 1-4 that are compatible with the embodiments of FIGS. 5-18 and/or do not conflict with these embodiments of FIGS. 5-18 can be claimed together with individual features of the embodiments of FIGS. 5-18.

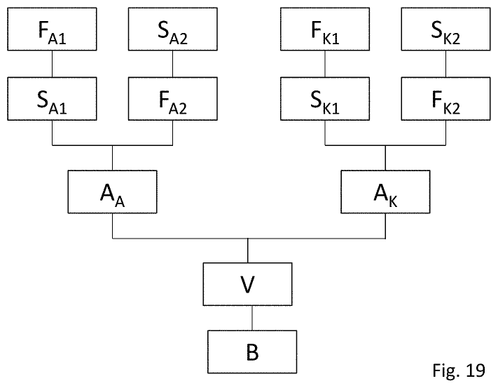

FIG. 19 schematically shows the method for producing the separator plate. When producing the two individual plates, it is possible to select either a process in which firstly the structures are embossed in the individual plate and then the apertures and through-openings are cut, for example punched, out of the individual plate, e.g. in the case of the anode plate first the step F_{A1} may be carried out and then the step S_{A1}, or a process in which firstly the apertures and through-openings are cut, such as punched, out of the individual plate and then the structures are embossed in the individual plate, e.g. in the case of the cathode plate first the step S_{K2} may be carried out and then the step F_{K2}. The final trimming of the outer edges of the two individual plates then usually takes place, step A_{A} for the anode plate or A_{K} for the cathode plate, before the two individual plates are joined, for example welded together, in step V and optionally coated in step B.

FIGS. 1-18D are shown approximately to scale. FIGS. 1-18D show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate for an electrochemical system, comprising a first individual plate and a second individual plate, which are connected to each other, wherein the separator plate comprises:
an electrochemically active region,
at least one through-opening for the passage of a fluid,
a bead arrangement arranged around the through-opening for sealing off the through-opening, wherein a bead interior is fluidically connected to the through-opening,
at least one first aperture formed in the first individual plate, which aperture extends substantially parallel to a plate plane defined by the separator plate, and
at least one conveying channel formed in the second individual plate, which conveying channel is arranged on one side of the bead arrangement,
wherein the conveying channel formed in the second individual plate opens into a region of the first individual plate containing the first aperture and fluidically connects the bead interior of the bead arrangement to the first aperture formed in the first individual plate.

2. The separator plate according to claim 1, wherein an orthogonal projection of the first aperture perpendicular to the plate plane onto the second individual plate defines a projection area, wherein the second individual plate has at least part of the conveying channel in the region of the projection area.

3. The separator plate according to claim 1, wherein, at least in some regions, the conveying channel extends from the bead arrangement in the direction of the electrochemically active region or in the direction of the through-opening.

4. The separator plate according to claim 1, wherein, at least in some regions, the conveying channel extends parallel and/or perpendicular to a main direction of extension of the bead arrangement.

5. The separator plate according to claim 4, wherein the conveying channel adjoins the bead arrangement.

6. The separator plate according to claim 1, wherein the first individual plate has a conveying channel which is fluidically connected to the bead interior, in some regions overlaps with the conveying channel of the second individual plate and is spaced apart from the first aperture.

7. The separator plate according to claim 1, wherein the first aperture is formed in a region of the plate that lies in a plate plane of the first individual plate.

8. The separator plate according to claim 1, wherein the first aperture is surrounded by an embossed structure.

9. The separator plate according to claim 8, wherein a height of the embossed region, measured perpendicular to the plate plane, is smaller than a height of the bead arrangement.

10. The separator plate according to claim 1, wherein the first aperture is spaced apart from the bead arrangement.

11. A separator plate for an electrochemical system, comprising a first individual plate and a second individual plate, which are connected to each other, wherein the separator plate comprises:
an electrochemically active region,
at least one through-opening for the passage of a fluid,
a bead arrangement arranged around the through-opening, at least in one of the individual plates, for sealing off the through-opening, wherein a bead interior is fluidically connected to the through-opening,
at least one first aperture formed in the first individual plate, which aperture extends substantially parallel to a plate plane defined by the separator plate, and
at least one conveying channel formed in one of the individual plates, which conveying channel is arranged on one side of the bead arrangement,
wherein the conveying channel opens into a region of the first individual plate containing the first aperture and fluidically connects the bead interior of the bead arrangement to the first aperture formed in the first individual plate.

12. The separator plate according to claim 1, wherein the conveying channel is arranged on a side of the bead arrangement facing away from the through-opening.

13. The separator plate according to claim 1, wherein the conveying channel is arranged on a side of the bead arrangement facing towards the through-opening.

14. The separator plate according to claim 1, wherein, in the first individual plate, no conveying channel extends between the bead arrangement and the first aperture.

15. The separator plate according to claim 1, wherein the first individual plate has at least two first apertures at least on the side of the bead arrangement facing away from the through-opening and/or facing towards the through-opening, wherein, in the first individual plate, an embossed structure extends, at least in some sections, between the two first apertures.

16. The separator plate according to claim 15, wherein, in the first individual plate, at least one conveying channel extends as an embossed structure, at least in some sections, between the two first apertures.

17. The separator plate according to claim 1, wherein the conveying channel is integrally formed in the individual plate by hydroforming, deep-drawing and/or embossing.

18. The separator plate according to claim 17, wherein the at least one first aperture is created in the first individual plate after the bead arrangement has been integrally formed.

19. A method for producing a separator plate according to claim 1, wherein the bead arrangement and/or the conveying channel is integrally formed in the individual plate by hydroforming, deep-drawing and/or embossing.

20. The method for producing a separator plate according to claim 19, wherein the at least one first aperture is created in the first individual plate before or after the bead arrangement has been integrally formed.
